(19) United States
(12) Patent Application Publication
(10) Pub. No.: US 2026/0255175 A1
(43) Pub. Date: Aug. 27, 2026

(54) ADAPTIVE VENUE SECURITY

(71) Applicant: INTERNATIONAL BUSINESS MACHINES CORPORATION, Armonk, NY (US)

(72) Inventors: Adam Lee GRIFFIN, Cohasset, MN (US); Nelisa Delgado VAN SLATE, Mableton, GA (US); Tiberiu SUTO, Franklin, NY (US); Chelsea Jean-Mary ISAAC, Alpharetta, GA (US)

(21) Appl. No.: 19/065,463

(22) Filed: Feb. 27, 2025

(51) Int. Cl. H04W 12/64; H04L 67/52; H04W 4/021; H04W 12/67

(52) U.S. Cl. CPC H04W 12/64; H04L 67/52; H04W 4/021; H04W 12/67

(57) ABSTRACT

Methods, computer program products, and systems are presented. The method computer program products, and systems can include, for instance: obtaining location data of a plurality of persons in a geospatial region coinciding with a geofence array, wherein the geofence array includes a geofence disposed about a venue, the geofence array defining a plurality of geofence zones; classifying persons of the plurality of persons in dependence on the location data as belonging to a certain zone of the plurality of geofence zones; generating geofence parameter values for the certain zone of the plurality of geofence zones, wherein the generating is performed in dependence on the classifying; inferencing one or more predictive model in dependence on a parameter value of the geofence parameter values; initiating action for remediation of a security risk condition associated to the venue in dependence on result data resulting from the inferencing.

### BACKGROUND

Embodiments herein relate to venue security, and particularly to adaptive venue security.

Venue security technology integrates advanced physical and digital security solutions to safeguard buildings and event spaces. Access control systems (ACS) use biometric authentication, RFID smart cards, and mobile-based digital keys to manage entry. Surveillance technology, and drone monitoring, enhances real-time oversight. Perimeter security employs smart fences, anti-ram barriers, and license plate recognition (LPR) for controlled access. Intrusion detection systems (IDS) use motion sensors, and glass-break detectors, to identify unauthorized activity. Cyber-physical security leverages IoT sensors, and secure network architectures for integrated risk management. Emergency and crowd management systems provide mass notifications, and automated evacuation protocols to handle crises efficiently. These technologies work together to prevent threats, enhance surveillance, and ensure rapid response in venues such as stadiums, airports, corporate buildings, and public spaces. The use of real-time data analytics enhances situational awareness, enabling proactive security measures to prevent incidents before they escalate.

Data structures have been employed for improving operation of computer systems. A data structure refers to an organization of data in a computer environment for improved computer system operation. Data structure types include containers, lists, stacks, queues, tables and graphs. Data structures have been employed for improved computer system operation, e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: obtaining location data of a plurality of persons in a geospatial region coinciding with a geofence array, wherein the geofence array includes a geofence disposed about a venue, the geofence array defining a plurality of geofence zones; classifying persons of the plurality of persons in dependence on the location data as belonging to a certain zone of the plurality of geofence zones; generating geofence parameter values for the certain zone of the plurality of geofence zones, wherein the generating is performed in dependence on the classifying; inferencing one or more predictive model in dependence on a parameter value of the geofence parameter values; and initiating action for remediation of a security risk condition associated to the venue in dependence on result data resulting from the inferencing.

In another aspect, a computer program product can be provided. The computer program product can include a computer readable storage medium readable by one or more processing circuit and storing instructions for execution by one or more processor for performing a method. The method can include, for example: obtaining location data of a plurality of persons in a geospatial region coinciding with a geofence array, wherein the geofence array includes a geofence disposed about a venue, the geofence array defining a plurality of geofence zones; classifying persons of the plurality of persons in dependence on the location data as belonging to a certain zone of the plurality of geofence zones; generating geofence parameter values for the certain zone of the plurality of geofence zones, wherein the generating is performed in dependence on the classifying; inferencing one or more predictive model in dependence on a parameter value of the geofence parameter values; and initiating action for remediation of a security risk condition associated to the venue in dependence on result data resulting from the inferencing.

In a further aspect, a system can be provided. The system can include, for example, a memory. In addition, the system can include one or more processor in communication with the memory. Further, the system can include program instructions executable by the one or more processor via the memory to perform a method. The method can include, for example: obtaining location data of a plurality of persons in a geospatial region coinciding with a geofence array, wherein the geofence array includes a geofence disposed about a venue, the geofence array defining a plurality of geofence zones; classifying persons of the plurality of persons in dependence on the location data as belonging to a certain zone of the plurality of geofence zones; generating geofence parameter values for the certain zone of the plurality of geofence zones, wherein the generating is performed in dependence on the classifying; inferencing one or more predictive model in dependence on a parameter value of the geofence parameter values; and initiating action for remediation of a security risk condition associated to the venue in dependence on result data resulting from the inferencing.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, sensor system, enterprise systems, and user equipment (UE) devices according to one embodiment.

FIG. 2 depicts a venue protected by a geofence array according to one embodiment.

FIG. 3A-3B depicts a flowchart for performance by manager system interoperating with UE devices, enterprise systems, models, and a sensor system according to one embodiment;

FIG. 4 depicts machine learning model according to one embodiment;

FIG. 5 depicts machine learning model according to one embodiment;

FIG. 6 is a flowchart illustrating a method for performance by a system according to one embodiment;

FIG. 7 depicts an artificial neural network (ANN) according to one embodiment;

FIG. 8 depicts a computing environment according to one embodiment.

### DETAILED DESCRIPTION

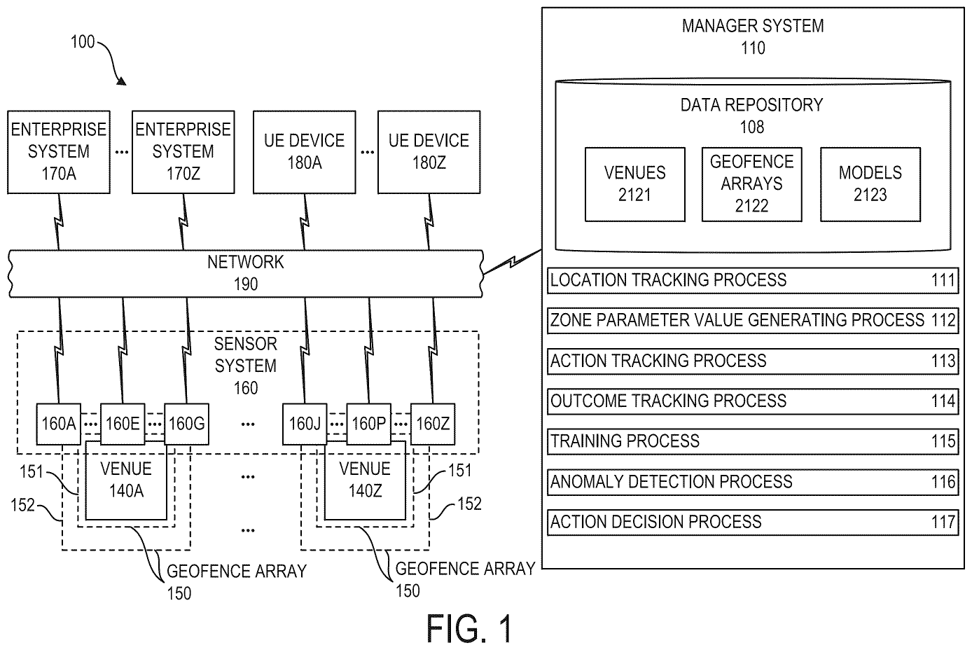

System 100 for protecting a venue is set forth in reference to FIG. 1. System 100 can include manager system 110 having an associated data repository 108, sensor system 160 having a plurality of sensors 160A-160Z for sensing location of users in respect to geofence arrays, enterprise systems 170A-170Z, and user equipment (UE) devices 180A-180Z. Manager system 110, sensor system 160, enterprise systems 170A-170Z, and UE devices 180A-180Z can be computing node based systems in communication with one another via network 190. Network 180 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Manager system 110 in one embodiment can be external to each of plurality of sensors 160A-160Z, enterprise systems 170A-170Z, and user equipment (UE) devices 180A-180Z. Manager system 110 in one embodiment can be collocated with or more of plurality of sensors 160A-160Z, enterprise systems 170A-170Z, and user equipment (UE) devices 180A-180Z.

Sensor system 160 can include plurality of sensors 160A-160Z disposed to sense location of persons in respect to least one geofence array disposed in a location coordinated with the location of a venue. Sensors of sensor system sensor devices 160A-160Z of sensor system 160 can include, e.g., camera imaging sensors, GPS sensors, smart phones carried by persons. Sensors 160A-160Z of sensor system 160 can include, e.g., sensors carried by persons, transmit radio signals to base stations, e.g., for triangulation based location sensing, and/or can include such base stations which detect radio signals transmitted from locations of users for performance of location sensing.

In the embodiment of system 100 set forth in FIG. 1, there are depicted a plurality of venues 140A-140Z, each having an associated geofence array 150. Geofence arrays 150 of venues 140A-140Z can include nested geofences that include a first geofence 151 and a second geofence 152, wherein the first geofence 151 is nested within second geofence 152.

Enterprise systems 170A-170Z can be, e.g., enterprises that own operator control venues that are protected with use of geofence arrays as set forth herein, and/or enterprises that support manager system 110. Enterprise of enterprise systems can be computing node-based systems of entities, e.g., business or government agency entities. One or more enterprise system of enterprise systems 170A-170Z can be a weather service system for generating weather data. One or more enterprise system of enterprise systems 170A-170Z can be a news aggregator system that aggregates newsfeeds. In one example, an enterprise system can be provided by a weather system. A weather service system can be configured to provide weather data with respect to an area being serviced by system 100. Weather data can include, e.g., historical temperature data, precipitation data, wind data and weather event data. Weather data can include, e.g., current temperature data, precipitation data, wind data and weather event data. Weather data can include, e.g., forecast temperature data, precipitation data, wind data and weather event data. Weather events can include, e.g., storms including hurricanes, tornados, fog formations, heat waves and cold waves. Weather service system can store weather data associated to different subareas of an area being serviced by system 100. Enterprise systems can include one or more news aggregator system. A news aggregator system can be provided by a news aggregator, e.g., a server with appropriate software for aggregating syndicated web content such as online new papers, blogs, podcasts in a central location for easy access. The news aggregator system can include a rich site summary (RSS) synchronized subscription system. RSS uses extensible markup language (XML) to structure pieces of information to be aggregated in a feed reader. Distributed updates can include, e.g., journal tables of contents, podcasts, videos, and news items. The news aggregator system can include human selected and entered content as well as automatically selected content, selected with use of auto-selection algorithms. Rich site summary (RSS) feeds can include text and metadata that specifies such information as publishing date and author name. The news aggregator system in one aspect can report on, e.g., vehicle traffic events, entertainment events, and the like.

UE devices 180A-180Z can be UE devices of users of system 100 and/or persons detected with use of system 100. Users can include agent users of enterprises associated to enterprise systems 110A-110Z and patron users of venues 140A-140Z. UE devices 180A-180Z can be provided by smartphones, laptops, tablets, smartwatches, PCs and the like. Person location sensing based on GPS and/or triangulation can depend on radio signal communication to and/from UE devices hand held by persons about a venue subject to location detection.

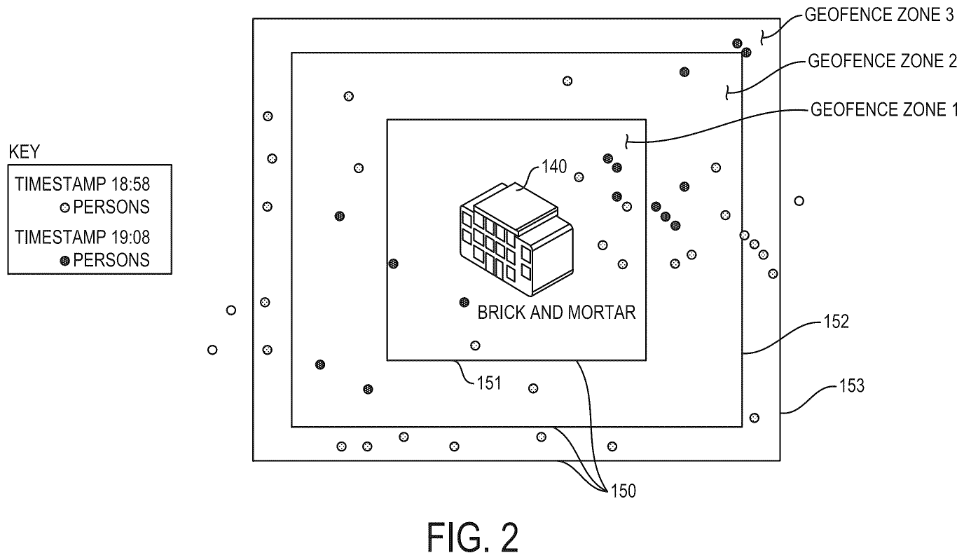

In FIG. 2 there is depicted protected venue 140, e.g., a brick and mortar venue protected by geofence array 150. Geofence array 150 can include a first geofence 151 encircling venue 140, a second geofence 152 circling first geofence 151 and venue 140, and third geofence 153 encircling second geofence 152 first geofence 151 and venue 140.

The first geofence 151 can be nested within second geofence 152, which can be nested within third geofence 153. The various geofences of geofence array 150 can define geofence zones. A first geofence zone 1 can be the zone internal to first geofence 151. A second geofence zone 2 can be defined by the area between first geofence 151 and second geofence 152. A third geofence zone 3 can be defined between the second geofence 152 and the third geofence 153. A fourth geofence zone 4 can be the zone outside of the third geofence 153. While FIG. 1 depicts two nested first and second nested geofences and FIG. 2 depicts first, second, and third nested geofences, a geofence array herein can include some instances only a single geofence and in some embodiments, as depicted in FIG. 1, can include a first geofence 151 nested within a second geofence 152. Embodiments herein recognize that geofence array that by classifying persons being associated to a geofence zone defined by one or more geofence, system 100 is able to strongly recognize patterns person movement within area of a geofence array.

Embodiments herein recognize that machine learning predictive models for return of predictions can consume extensive computing resources including computing resources for training. Embodiments herein recognize that high-dimensional or irrelevant features can increase model complexity, leading to slower convergence and unnecessary memory usage. If data is not properly normalized or distributed, gradients can be unstable, slowing optimization and requiring more iterations to reach a satisfactory solution. Embodiments herein recognize that poorly configured training data can be a major source of computational inefficiency, causing excessive resource consumption and prolonged training times. Embodiments herein recognize that noisy, redundant, or mislabeled data can lead a neural network to waste processing cycles learning patterns that do not contribute to generalization, forcing additional epochs to correct inconsistencies. Embodiments herein recognize that imbalanced datasets can bias the model, requiring resampling or reweighting, which adds to the computational load. Embodiments herein recognize that poor sampling strategies can result in insufficient diversity, causing overfitting and necessitating additional regularization techniques that extend training time. Embodiments herein recognize that inefficient data augmentation can unnecessarily increase dataset size and computational overhead, while excessive augmentation can degrade model performance, forcing retraining. Embodiments herein recognize that erratic loss landscapes from poorly curated data can lead to unstable gradient updates, prolonging backpropagation and increasing floating-point operations. Embodiments herein recognize that suboptimal data quality can make hyperparameter tuning more expensive, requiring repeated training cycles to compensate for learning inefficiencies. Embodiments herein recognize that training a neural network is inherently resource-intensive, consuming vast computing power, memory, and energy, but ensuring clean, balanced, and well-structured data can significantly reduce computational waste, improve training efficiency, and enhance model performance. By optimizing dataset quality before training, unnecessary iterations, excessive computations, and wasted resources can be minimized, making AI development both faster and more sustainable.

Geofences zone classifiers herein facilitate generation of lightweight zone classifier based parameter values (“geofence zone parameter values”) with minimal dimensionality. The lightweight zone classifier based parameter values can facilitate real-time predictions as to conditions with use of predictive models that can be trained with economization of computing resources.

Embodiments herein recognize in one aspect that generating geofence zone parameter values provides high quality training data for training of a machine learning of a predictive model, facilitating accurate detection of anomalies and other conditions with economized computing resources. The use of a geofence can help reduce the number of dimensions in training data by restricting data collection to a specific geographic area, thereby eliminating irrelevant spatial information. Spatial filtering ensures that only location-specific data is included, removing unnecessary latitude/longitude coordinates from distant regions. Environmental complexity is reduced, as models no longer need to account for diverse climate, infrastructure, or population differences. Movement patterns become simpler, as tracking is confined within the geofence, eliminating the need for additional variables related to cross-region behaviors. Additionally, noise from unrelated data sources such as distant Wi-Fi networks or cell towers is minimized, improving signal relevance. By limiting data collection within a controlled boundary, feature selection becomes more efficient, requiring fewer variables to describe spatial relationships. This reduction in dimensionality lowers computational costs, speeds up training, and improves model performance by reducing redundant or unnecessary processing. In essence, geofencing ensures that training data remains focused, relevant, and computationally efficient, making it an effective strategy for optimizing machine learning models while conserving resources.

In FIG. 2. there are depicted locations of users over time, i.e., at different snapshot data capture periods over time. In FIG. 2, there are depicted first and second timestamps, specifying data collection times of location data for users of persons being detected. Use of geofence zones a set forth herein, manager system 110 is able to generate zone parameter values that facilitate detection of anomalies in a person movement with economized utilization of computing resources including processing resources and computer program memory resources.

Data repository 108 can store various data. In venues area 2121, data repository 108 can store data on venues, being protected by system 100. Venues herein can include brick-and-mortar venues and/or outdoor venues. Venues herein can include, e.g., schools, municipal buildings, parks, item acquisition venues, e.g., retail stores, and the like.

Data repository 108 in geofence arrays area 2122 can store data on geofence arrays established in respect to venues being protected with use of system 100. Geofence data of geofence arrays area 2122 can include, e.g., configuration data, specifying a configuration of geofence array, e.g., how many nested geofences the array includes the dimensions of such geofences, and the like. Geofence data stored within geofence arrays area 2122 can also store for each geofence array geofence parameter value historical data. In geofence arrays area 2122 there can be stored data for supporting venue security of respective venues associated to the respective geofence arrays, e.g., person location data, geofence zone parameter values, weather data of a geofence array, events data of a geofence array, action tracking data of a geofence array, outcome tracking data of a geofence array, recorded anomaly detections, and the like.

Geofence parameter values can include, e.g., a density of persons within a geofence zone, an average in aggregate dwell time persons within, a geofence zone in aggregate trajectory of persons within a geofence zone, and the like. Geofence parameter values can include raw unstructured parameter values, e.g., parameter values specifying a person identifier and coordinate locations for a time capture period of a certain timestamp. The person identifier can map to an actual enterprise-assigned identifier for a person, e.g., phone number, social media address, or, if the person is “unknown” but recognized by manager system 110 manager system 110 can assign a temporary ID to such person for management of a session. Recorded parameter values stored within geofence arrays area 2122 can be timestamped. Data of geofence arrays area 2122 can be used to train one or more predictive model that is trained by machine learning.

In models area 2123, data repository 108 can store machine learning predictive models that have been trained by machine learning. Models in models area 2123 can include, e.g., machine learning models trained for predicting an anomalous person movement pattern condition. A model within models area 2123 can also include, e.g., a model for predicting impact of remediation action in response to a sensed anomalous person movement pattern condition.

Manager system 110 can run various processes. Manager system 110 running location tracking process 111 can include manager system 110 iteratively obtaining location data of persons associated to geofence arrays 150A-150Z as shown in FIG. 1 over time. Persons subject to location tracking can include, e.g., persons on foot, and/or persons in vehicles, e.g., multi-person (cars, trucks, etc.) or single person vehicles such scooters, bicycles, etc.

Various location tracking technologies can be employed for performance of location tracking. Location tracking can include, e.g., video camera based location tracking, satellite-based location tracking, e.g., with use of a global positioning system (GPS), ground-based radio signal location tracking, e.g., using triangulation, and the like. Sensor system 160 can include a plurality of sensors 160A-160Z, e.g., defined by camera sensors, GPS sensors, base stations, UE devices disposed at various locations for detecting locations of persons in respect to geofences arrays 150. Where a location sensor of sensors 160A-160Z is included in a UE device the sensor can be collocated on a UE device of UE devices 180A-180Z. Camera-based, GPS-based, cellular, and Wi-Fi triangulation technologies each provide distinct yet complementary methods for detecting and counting individuals within a geofenced area defined by geofence array 150, and their integration significantly enhances accuracy and reliability.

Camera-based detection relies on AI-powered computer vision algorithms analyzing live video feeds from surveillance cameras to count individuals based on shape, movement, and facial or body recognition. Advanced models can differentiate between humans and objects, track individuals to prevent double-counting, and even detect demographic characteristics, though accuracy can be affected by camera placement, lighting conditions, and visual obstructions. GPS-based tracking involves mobile devices transmitting their geolocation data through dedicated apps or system-level permissions, providing precise location data for those who have opted in, making it particularly useful for controlled environments such as workplace monitoring or event management but ineffective for passive, large-scale population estimation due to privacy concerns and user opt-in requirements. Cellular triangulation leverages signal strength and timing data from multiple nearby cell towers to estimate a device's position within a defined coverage area. This method offers broad, network-based coverage and does not require active user participation, making it a scalable approach for estimating large-scale crowd presence. Wi-Fi triangulation can function similarly by measuring signal strengths from multiple Wi-Fi access points, offering more precise location data in urban settings and enclosed spaces where GPS and cellular methods may struggle. Since Wi-Fi networks are typically denser in areas with high foot traffic, such as shopping malls, airports, and event venues, this method is particularly useful for indoor population tracking. Combining these four technologies allows for an optimized approach to people counting within a geofenced region: cameras deliver real-time, visual confirmation of crowd density; GPS tracking provides accurate, user-specific location data when consent is given; cellular triangulation offers a passive, large-scale solution for estimating presence without requiring direct user interaction; and Wi-Fi triangulation refines indoor tracking by leveraging signal analysis for increased accuracy. By integrating these systems, organizations can improve crowd management, analyze movement patterns, and enforce geofencing regulations with high precision, making them valuable for security monitoring, smart city planning, retail analytics, emergency response, and event crowd control. However, deployment of these technologies must carefully balance effectiveness with privacy considerations, as passive data collection through cellular and Wi-Fi networks may raise concerns about unauthorized tracking, while camera-based and GPS monitoring require adherence to data protection regulations and ethical usage guidelines. Infrastructure constraints also play a critical role in implementation, as reliable cellular triangulation depends on the number of cell towers, Wi-Fi tracking requires an extensive network of access points, and camera-based systems need high-quality hardware and optimized positioning to minimize blind spots. Ultimately, the integration of these detection methods provides a scalable, flexible, and increasingly precise approach to population estimation within a geofenced area, facilitating applications across various industries while necessitating transparent policies and technological safeguards to ensure compliance with privacy standards and ethical best practices.

Manager system 110 running geofence zone parameter value generating process 112 can include manager system 110 generating one or more geofence zone parameter value in respect to one geofence array that has been arranged to protect a venue, e.g., geofence array 150 for protection of a venue. Manager system 110 running zone parameter value generating process 112 can include manager system 110 generating such zone parameter values as zone person density zone to get dwell time, zone trajectory, and the like.

In recording parameter values for a given geofence array 150, manager system 110 can classify parameter values in terms of zones, wherein each geofence zone specifies a location in respect to one or more geofence defining a geofence array. In one embodiment a first geofence zone refers to geospatial locations within a first geofence, a second geofence zone can refer to locations outside a first geofence but inside the second geofence where the first geofence is nested within the second geofence, and a third geofence zone can refer to locations outside of the described second geofence encircles the first geofence but inside a third geofence that encircles the second, and first geofences. Geofence arrays herein can include two or more geofences that are in nested relation, wherein a first of the geofence is nested within the second of the geofence.

Manager system 110 running action tracking process 113 can include manager system 110 tracking risk remediation actions taken by enterprises in response to an observed risk condition. Remediation actions can include, e.g., closure and/or locking of gates, doors, corridors, or sensitive areas; adjustments to climate control systems [HVAC]; notification of private security, local authorities; notification or to “call up” reserve employees/labor forces; robotic based responses [i.e., inventory/production responses]; security system initiation, crowd/theft suppression systems, activating a Faraday cage within a venue to disrupt radio communication involving UE devices within the venue, and the like.

Manager system 110 running outcome tracking process 114 can include manager system 110 tracking an outcome resulting from performance of an action taken by an enterprise for remediation of a risk condition. Manager system 110, performing outcome tracking process 114 can include manager system 110 e.g., determining whether a risk condition associated with one or more persons has been resolved, determining whether a risk condition associated with one or more persons no longer exists, whether there was a false alarm.

Manager system 110 running training process 115 can include manager system 110 performing training of a machine learning model. Machine learning training of one or more machine learning predictive model can be based on data obtained by manager system 110, either by receipt or generation. Manager system 110 running training process 115 can include manager system 110 training a machine learning predictive model for detection of an anomalous person movement pattern.

Manager system 110 running training process 115 can include manager system 110 training of a machine learning predictive model for return of a prediction as to best action to take in response to a risk condition. Manager system 110 running action decision process 117 can include manager system 110 returning an action decision for remediation of a risk condition.

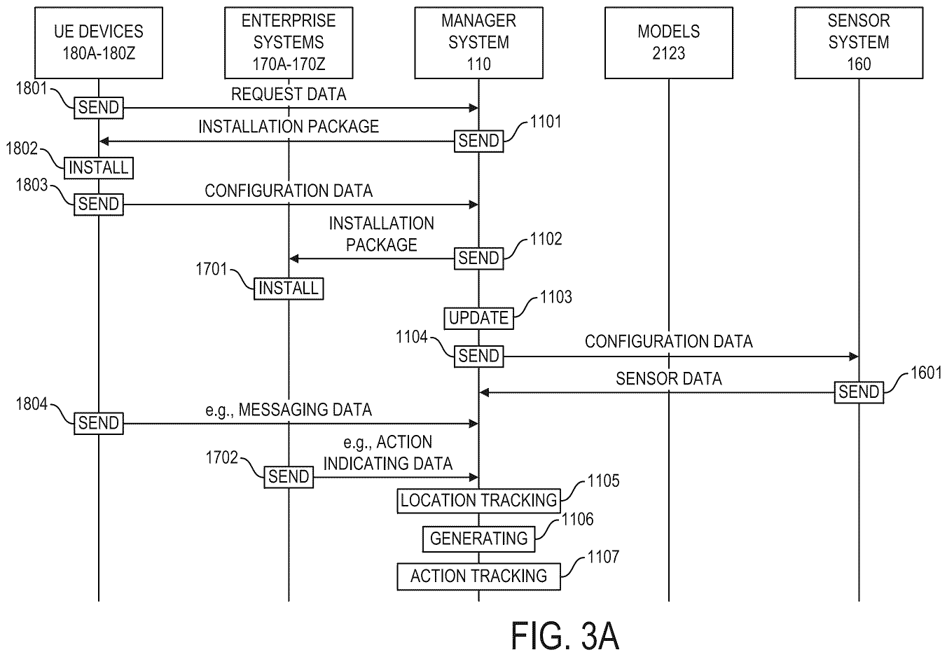

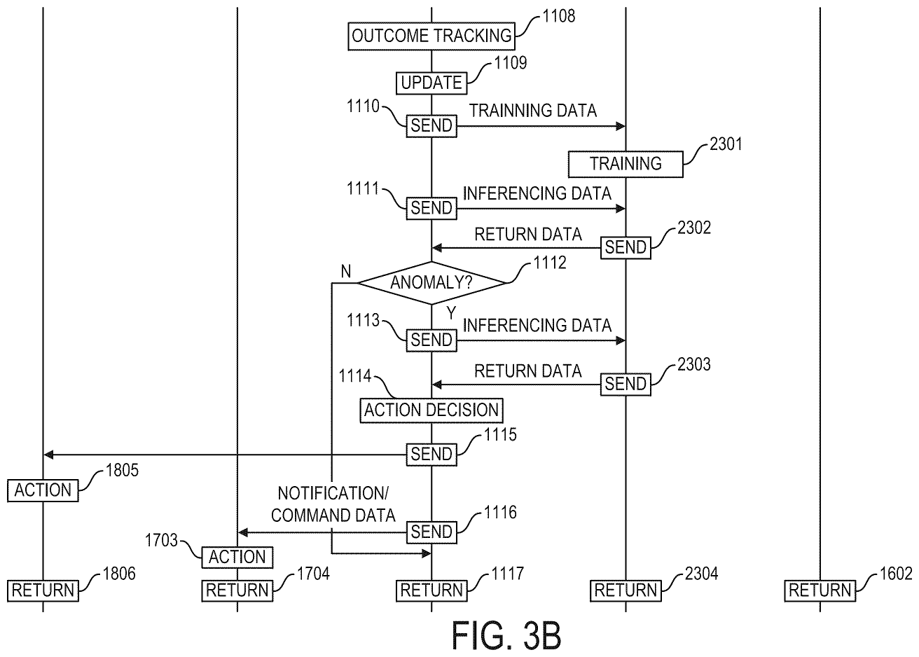

A method for performance by manager system 110 interoperating with UE devices 180A-180Z, enterprise systems 170A-170Z, models of models area 2123, and sensor system 160 is set forth in reference to the flowchart of FIGS. 3A-3B.

At block 1801, UE devices 180A-180Z can be sending request data for requesting entry of an enterprise as a registered user. Requesting users of UE devices 180A-180Z can be agent users associated to venue operating enterprises of enterprise systems 170A-170Z. Enterprise systems 170A-17Z can include venue operating enterprises and non-venue operating enterprises.

At send block 1801, UE devices 180A-180Z can be sending request data. The request data sent at block 1801 can include request data for receipt by manager system 110 requesting registration of an enterprise for services provided by manager system 110. The request data can include registration data that specifies baseline information on a venue for which security is requested and its associated computing resources.

On receipt of the request data sent at block 1801, manager system 110 can proceed to send block 1101 and send block 1102. At send block 1101, manager system 110 can send an installation package for receipt to the request data sending UE device being request data at block 1801. At send block 1102, manager system 110 can send an installation package for receipt by an enterprise system associated to the user initiating the sending of request data sent at block 1801. On receipt of the installation package sent at send block 1101, the sending UE device can install the installation package at install block 1802. The installation package installed at block 1801 can configure the UE device for operation within system 100. In one example, the installation code installed in the installation package installed at block 1801 can include code enabling presentment of a user interface for input of control data into manager system 110. On completion of install block 1802 the UE device can proceed to send block 1803 to send configuration data defined using the installed user interface. At send block 1103 for a given UE device (i.e., after installation at install block 1802) the UE device can send configuration data. Configuration data can include, e.g., geofence array settings, risk condition criterion settings, action settings, action detection settings, detected outcome settings, and the like. The configuration data sent at send block 1803 can specify, e.g., geospatial locations of a venue to be protected and geospatial locations of one or more geofence defining the geofence array protecting the venue.

On receipt of the configuration data sent at send block 1803, manager system 110 can proceed send block 1102. At send block 1102, manager system 110 can send an installation package for installation on an enterprise system associated to the user sending the request data sent at block 1801, and on receipt of the installation package sent at send block 1102 a certain enterprise can install the installation package at install block 1701. The installation package can configure the enterprise for operation within system 100. In one aspect, the installation package installed at install block 1701 can facilitate messaging between applications and/or services of the installing enterprise system of enterprise systems 170A-170Z and manager system 110.

On completion of send block 1102, manager system 110 can proceed to update block 1103. At update block 1103, manager system 110 can update geofence arrays area 2122 to include any registration data for a protected venue received responsively to send block 1801, and/or any configuration data received responsively to send block 1803.

On completion of update block 1103, manager system 110 can proceed send block 1104. At send block 1104, manager system 110 can send configuration data to sensor devices of sensor system 160. The configuration data can include command data commanding such sensor devices to report back sensor data for sensing locations of persons within an updated set of geofence arrays updated at update block 1103. In response to the configuration data sent at send block 1104, the newly configured sensor devices and any earlier configured sensor devices can report their sensor data to manager system 110 at send block 1601. Sensor system 160 can be configured to support location sensing, as well as other sensing, such as camera based pattern recognition wherein action of persons within a geofence array can be detected.

At send block 1804, UE devices 180A-180Z can be sending, e.g., messaging data for receipt by manager system 110, and at send block 1702 enterprise systems 170A-170Z can be sending, e.g., action indicating data receipt by manager system 110. Sensed remediation actions sensed with data sent at block 1601 and/or block 1702 can include, e.g., closure and/or locking of gates, doors, corridors, or sensitive areas; adjustments to climate control systems [HVAC]; notification of private security, local authorities; notification or to “call up” reserve employees/labor forces; robotic based responses [i.e., inventory/production responses]; security system initiation, crowd/theft suppression systems, activating a Faraday cage within a venue to disrupt radio communication involving UE devices within the venue, and the like. In one embodiment, an HVAC can be configured to enrich oxygen levels in an environment.

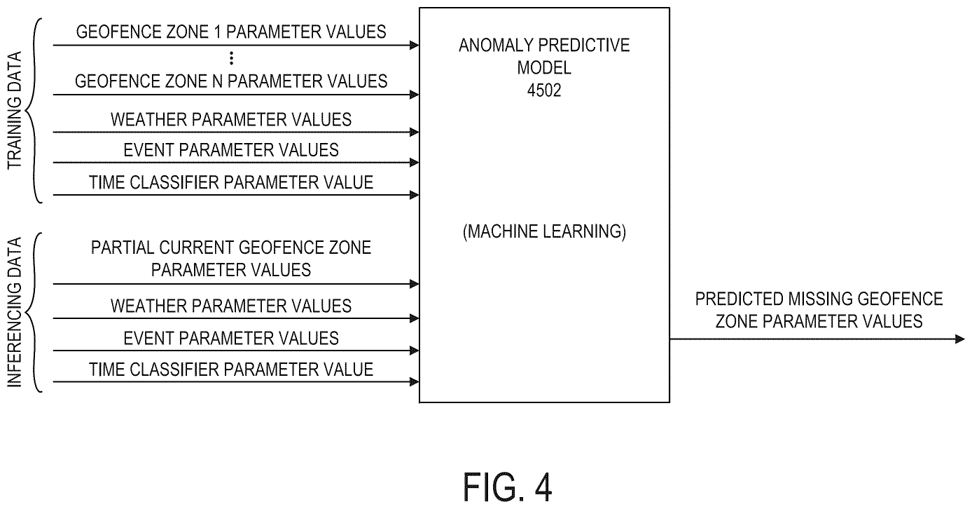

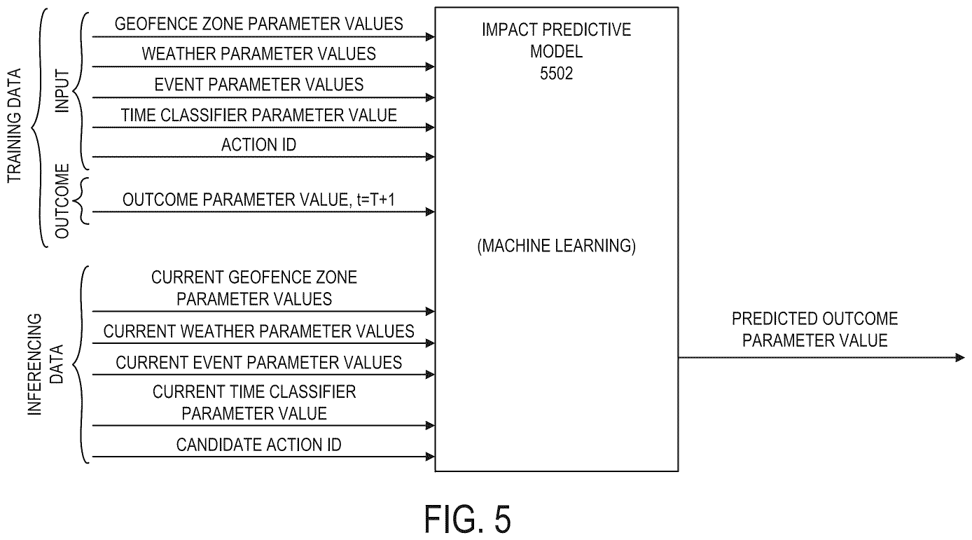

Data sent a send block 1702 from enterprise systems 170A-170Z can further include, e.g. weather data and news aggregator system data specifying, e.g., entertainment events. Such data can be useful in training machine learning predictive models, as are referenced in connection with FIG. 4 and FIG. 5 herein.

On receipt of the sensor data sent at block 1601 and any data sent at block 1804 and block 1702, manager system 110 can proceed to location tracking block 1105. At location tracking block 1105, manager system 110 can track, and store location data specifying current location of persons associated to a geofence array set forth herein. At location tracking block 1105, manager system 110 can record within geofence arrays area 2122 for a certain geofence array the current specific time stamped location of all persons identified as being currently located in an area of a geofence array associated to a venue. At location tracking block 1105, manager system 110 can record for each detected person a specific coordinate location of the person as well as a geofence zone classification of the first geofence zone one, geofence two, or geofence zone three, as set forth in reference to FIG. 2.

On completion of location tracking block 1105, manager system 110 can proceed to generating block 1106. At generating block 1106, manager system 110 can perform generating a parameter value dataset for respective defense zones of a geofence array protecting a given venue. In one embodiment, for each geofence zone, manager system 110 at generating block 1106 can generate (a) a person density geofence zone parameter value which specifies the population density of persons within the zone, (b) a dwell time geofence zone parameter value that specifies an average dwell time of persons within the zone, and (c) a trajectory geofence zone parameter value that specifies the average direction of persons of the zone when breaching the geofence to enter the zone, (d) a growth rate geofence zone parameter value. To track the average direction at which people breach a geofence, location data can be analyzed using trajectory processing and vector-based movement analysis. First, each individual's location points are collected upon entry and exit of the geofence using GPS logs, mobile device data, or Wi-Fi/Bluetooth signals. The key data points include entry timestamp, exit timestamp, latitude, and longitude. Using this data, direction vectors are calculated by determining the bearing angle between the geofence entry and exit points. This is done using the Haversine formula or bearing calculation equations based on latitude-longitude pairs. The individual vectors are then aggregated, and their average direction is computed using vector summation and normalization to avoid distortions from opposite-direction movements canceling each other out.

Manager system 110 can generate geofence zone parameter values as set forth in Table A.

TABLE A

| Row | Geofence zone parameter value | Description |
|---|---|---|
| 1 | Person density geofence | specifies the population density |
| | zone parameter value | of persons within the zone |
| 2 | Dwell time geofence zone | specifies an average dwell time |
| | parameter value | of persons within the zone |
| 3 | Trajectory geofence zone | specifies the average direction |
| | parameter value | of persons of the zone when |
| | | breaching the geofence to enter |
| | | the zone |
| 4 | Growth rate geofence zone | specifies population density |
| | parameter value | growth rate by examining the |
| | | current person density geofence |
| | | parameter value with one or |
| | | more prior capture time person |
| | | density geofence parameter |
| | | value |
| . . . | . . . | . . . |

For the parameter values (b) and (c), manager system 110 can examine location tracking data of recent historical location data collection times, i.e., in order to determine dwell time and trajectory of individual instances of persons entering zone.

On completion of generating block 1106, manager system 110 can proceed to action tracking block 1107. At action tracking block 1107, manager system 110 can examine data sent at block 1601, block 1804 and/or block 1702 in order to track actions performed by enterprises and/or users for remediation of a risk condition. Actions tracked and recorded at action tracking block 1107 can include such actions as remediation actions can include, e.g., closure and/or locking of gates, doors, corridors, or sensitive areas; adjustments to climate control systems [HVAC]; notification of private security, local authorities; notification or to “call up” reserve employees/labor forces; robotic based responses [i.e., inventory/production responses]; security system initiation, crowd/theft suppression systems, activating a Faraday cage within a venue to disrupt radio communication involving UE devices within the venue, and the like. Activating a Faraday cage can include closing a ground path to mesh defining the Faraday cage. In an active state the Faraday cage can disrupt radio signal communications involving UE devices within a venue. In an inactive state the Faraday cage can permit radio signal communications involving UE devices within a venue.

On completion of action tracking block 1107, manager system 110 can proceed to outcome tracking block 1108. At outcome tracking block 1108, manager system 110 can record in geofence arrays area 2122 outcome data that specifies a result of previously performed action tracked at action tracking block 1107.

Outcomes tracked at outcome tracking block 1108 based on data sent at block 1601, block 1804, and/or block 1702 can include, e.g., determining whether a risk condition associated with one or more persons has been resolved, which can be automatically determined from pattern recognition via camera surveillance, and/or news aggregator system notification, determining whether a risk condition associated with one or more persons no longer exists, which can be automatically determined from pattern recognition via camera surveillance, and/or news aggregator system notification, data indicating a false alarm. In one use case, manager system 110 can present agent users of an enterprise operating a protected venue with a user interface that permits the user to specify that an alerted to risk condition causing action to occur was a false alarm (there was no actual risk condition). Manager system 110 can also detect the false alarm condition automatically, e.g., via pattern recognition to ascertain those persons initially flagged as being associated with a risk condition.

On completion of outcome tracking block 1108, manager system 110 can proceed to update block 1109. At update block 1109, manager system 110 can update geofence arrays area 2122 of data repository 108 with updated location tracking data generated parameter value datasets generated at block 1106, action tracking data determined at block 1107, and outcome tracking data determined at block 1108. On completion of updating block 1109, manager system 110 can proceed to send block 1110. At update block 1109, manager system 110 can update geofence arrays area 2122 to include all data received responsively to send block 1601, send block 1804 and/or send block 1702.

At send block 1110, manager system 110 can send training data for training one or more predictive model stored in models area 2123. In response to receipt of the training data, the models can be trained as indicated at training block 2301.

With the pushing of training data at send block 1101 for performance of training at training block 2301, manager system 110 can proceed simultaneously to send block 1111. At send block 1111, manager system 110 can send inferencing data for inferencing one or more trained model as trained at training block 2301. The performance of training simultaneously with inferencing reduces latencies and improves performance of computing node made manager system 110. Embodiments herein recognize that while training at training block 2301 can include latencies, the latencies can be managed so that advantages of machine learning are yielded with improved performance of a computer system defined by manager system 110. In one aspect, geofence zone parameter values reduce data dimensionality to reduce training computing resources. In another aspect, with training at training block 2301 performed simultaneously and in parallel with blocks 1101-1117, blocks 1101-1117 can be performed in real time, i.e., without perceivable delay to a user.

Embodiments herein recognize that due to training latencies and response latencies, the inferencing data sent at send block 1111 can be sent to a prior instance of a given model that is being subject to training at training block 2301 and that training at training block 2301 can include training with respect to a define a trained instance of a model for inferencing at a subsequent instance of send block 1111 for sending inferencing data.

Training at training block 2301 can include training of anomaly predictive model 4502 as set forth in FIG. 4 and impact predictive model 5502 as set forth in FIG. 5. Anomaly predictive model 4502 at FIG. 4 can be used to return predictions as to anomalies occurring with respected person movement patterns. Impact predictive model 5502 as set forth in FIG. 5 can be used for return of predictions as to an impact of a remediation action taken with respect to a risk condition.

Referring to anomaly predictive model 4502 of FIG. 4, anomaly predictive model 4502 can be trained with iterations of training data, and once trained, can be configured to respond to inferencing data. Iterations of training anomaly predictive model 4502 can include as shown in FIG. 4 geofence zone parameter values for each geofence zone of N geofence zones, weather parameter values for the given historical capture time, event parameter value specifying event classifiers for an event, e.g., entertainment event occurring with respect to a geospatial area of a protecting geofence array, and a time classifier parameter value. The geofence zone parameter values can include the geofence zone parameter values as set forth herein, including (a) a person density geofence zone parameter value which specifies the population density of persons within the zone, (b) a dwell time geofence zone parameter value that specifies an average dwell time of persons within the zone, (c) a trajectory geofence zone parameter value that specifies the average trajectory of persons of the zone when breaching the geofence to enter the zone, (d) a growth rate geofence zone parameter value. Embodiments herein recognize that person movement patterns can take on various expected patterns that differ dependent on a time classifier, e.g., workday day, morning rush-hour workday, afternoon rush hour, weekend, holiday, and the like. The input time classifier value input into anomaly predictive model 4502 within each iteration of training data can specify the time classifier for the data collection time associated to the given training iteration.

Manager system 110 at iterations of training block 2301 can input iterations of training data, wherein each iteration of training data is associated to a certain historical data capture time. Manager system 110 in training anomaly predictive model can apply iterations of training data on a self-supervised learning scenario. Various training data can be segregated as being either input training data or outcome training data, and these roles can switch between training iterations.

In one example, for a given historical data capture time, manager system 110 can apply three training iterations for a given data capture time where there are first, second, and third geofence zones.

In a first iteration, geofence zone parameter values of geofence zone 1 can be applied outcome training data and geofence zone parameter values of geofence zone 2 and geofence zone 3 can be applied as input training data with the geofence zone parameter values of geofence 1 being masked from the input training data. In a second iteration for the given data capture time, geofence zone parameter values of the geofence zone 2 can be applied as outcome training data and geofence zone parameter values for geofence zone 1 and geofence zone 3 can be applied is input training data with the geofence zone parameter values of geofence 2 being masked from the input training data. For the third iteration, geofence zone parameter values of geofence zone 3 can be applied as outcome training data and geofence zone parameter values of geofence zone 1 and geofence 2 can be applied is input training data with the geofence zone parameter values of geofence 3 being masked from the input training data.

Trained as described using the self-supervised learning technique, anomaly predictive model 4502 can learn relationships between geofence zone parameter values of different geofence zones. Based on the training described, anomaly predictive model 4502 can be trained to be used for detection of anomalous person movement patterns. Anomaly predictive model 4502, once trained, can be inferenced with use of inferencing data. The use of a geofence for generating geofence zone parameter values can help reduce the number of dimensions in training data by restricting data collection to a specific geographic area, thereby eliminating irrelevant spatial information. Spatial filtering ensures that only location-specific data is included, removing unnecessary latitude/longitude coordinates from distant regions.

The self-supervised learning (SSL) approach described can significantly economize computing resource utilization when training a neural network by reducing dependency on labeled data and improving data efficiency. Since the self-supervised learning approach learns from unlabeled data, it eliminates the costly need for manual annotation, making training more scalable. Efficient pretraining allows a model to extract features from large datasets before fine-tuning on smaller labeled datasets, reducing the number of training iterations. Additionally, the described self-supervised learning approach can facilitate transfer learning, enabling pretrained models to be reused for multiple tasks with minimal additional training, further cutting down computational overhead.

Inferencing data for inferencing anomaly predictive model 4502 can include a subset of current geofence zone parameter values, current weather parameter values, current event, social event parameter values, and a time classifier parameter value for the current time. On being inferenced as described, anomaly predictive model 4502 can output a prediction as to missing geofence zone parameter values for the missing geofence zone or zones, i.e., the one or more geofence zone not included in the inferencing data for inferencing anomaly predictive model 4502.

For detection of anomaly, manager system 110 can compare the predicted missing geofence on parameter values to the holdout geofence zone parameter values held out from the inferencing described for inferencing anomaly predictive model 4502. Manager system 110 can ascertain that an anomaly condition is present when the difference between the predicted missing geofence parameter values and the holdout geofence zone parameter values satisfies a threshold difference indicative of there being an anomaly condition. For protecting a venue, manager system 110 can detect a convergence anomaly condition in which unscrupulous persons converge upon a venue. Manager system 110 can ascertain that a convergence anomaly condition is present when the difference between the predicted missing geofence parameter values and the holdout geofence zone parameter values satisfies a threshold difference indicative of there being an anomaly condition, and where a geofence zone person density parameter value of one or more geofence (generated at generating block 1106) of a geofence array exceeds a predicted zone person density parameter value (determined responsively to inferencing at inferencing data send block 1113) for the one or more zone by a threshold satisfying value.

As set forth in FIG. 5, training at training block 2301 of impact predictive model 5502 can include training impact predictive model 5502 with use of supervised learning. Iterations of training data can include input training data and outcome training data. Input training data for each training iteration can include geofence zone parameter values, weather parameter values, event parameter values, a time classifier parameter value, e.g., workday, weekend, and the like, an action ID, i.e., specifying the action taken, which can include such actions as e.g., closure and/or locking of gates, doors, corridors, or sensitive areas; adjustments to climate control systems [HVAC]; notification of private security, local authorities; notification or to “call up” reserve employees/labor forces; robotic based responses [i.e., inventory/production responses]; security system initiation, crowd/theft suppression systems, activating a Faraday cage within a venue to disrupt radio communication involving UE devices within the venue, and the like, as set forth in further in respect to the training data for each training iteration.

Outcome training data can include an outcome parameter value. In respect to each training iteration, the input training data can include training data synchronized to a data collection time prior to the data collection time of the outcome parameter value applied as outcome training data. That is, for each training iteration in which time t is advancing the input training data can be associated to time t=T and outcome parameter values can be outcomes at the time t=T+1. Outcome training data can include magnitude values that indicate the strength (impact) associated to the outcome. Manager system 110 can assign outcome magnitudes with use of a decision data structure as is set forth in Table B. Manager system 110 can scale impact magnitudes on a scale of 0.0 to 1.0 wherein scoring values of less than 0.5are assigned for impact that is negative, 0.5 for neutral impact, and above 0.5 for positive impact outcomes that are scaled in dependence on the success of the action taken.

TABLE B
(tracked outcome scoring)

| Row | Outcome | Assigned Magnitude |
|---|---|---|
| 1 | Single false alarm reporting | 0.1 |
| 2 | Multiple false alarm reporting | 0.0 |
| | instances | |
| 3 | No recognition of outcome | 0.5 |
| 4 | Recognition of single person | 0.6 |
| | associated with risk condition | |
| 5 | Recognition of multiple persons | 0.7 |
| | associated with risk condition | |
| 6 | Recognition of single person | 0.8 |
| | associated with risk condition | |
| | mitigation | |
| 7 | Recognition of multiple persons | 1.0 |
| | associated with risk condition | |
| | mitigation | |
| . . . | . . . | . . . |

Trained as described, impact predictive model 5502 can learn a relationship between applied actions, other factors, geofence state as expressed in terms of geofence zone parameter values, and outcome realized at a subsequent time.

Impact predictive model 5502, once trained, can be responsive to inferencing data. Inferencing data for inferencing impact predictive model 5502 can include various data. Inferencing data for inferencing impact predictive model 5502 can include current geofence zone parameter values, current weather parameter values, current social event parameter values, a current time classifier parameter value, specifying a time classifier for the current time, and a candidate action ID, e.g., mapping to one of the action set forth in Table C.

TABLE C
(Action classifiers)

| Row | Action classifier | Description |
|---|---|---|
| 1 | Notif_1 | Text messages sent to in venue |
| | | personnel |
| 2 | Notif_2 | Text messages sent to in venue |
| | | personnel and venue owners |
| 3 | Gate_1 | Front venue gate closed |
| 4 | Gate_2 | All venue gates closed |
| 5 | Farad_1 | Faraday gate selectively activated |
| | | at front of venue |
| 6 | Farad_2 | Faraday gate selectively activated |
| | | throughout venue |
| 7 | Notif_3 | Venue loudspeaker notification of |
| | | detected risk condition |
| 8 | HVAC_1 | Climate condition 1 imposed on |
| | | venue |
| 9 | . . . | . . . |

Manager system 110 can apply a set of inferencing data as set forth in FIG. 5 for each action ID of a candidate set of action IDs. Inferenced as described, impact predictive model 5502 with the training described can output a predicted outcome parameter value. Manager system 110 can apply the inferencing data dataset as described in reference to FIG. 5 for each of N different candidate action IDs mapping to the actions specified in Table C. Manager system 110 can select, e.g., the highest J scoring actions for implementation, where J is greater than or equal to 1.

Returning again to the flowchart of FIG. 3A-3B, manager system 110 on completion of training data send block 1110 can proceed to send block 1111. At send block 1111, manager system 110 can perform inferencing as described in reference to inferencing of anomaly predictive model 4502 set forth in reference to FIG. 4. In response to being inferenced with the described inferencing data, anomaly predictive model 4502 at send block 2302 can return to manager system 110 return data. The returned data can include the output data described in reference to anomaly predictive model 4502 as set forth in FIG. 4. Manager system 110 can be sending multiple iterations of inferencing data, e.g., each iteration specifying a different subset of current geofence zone parameter values, e.g., a first iteration for geofence zone one, second iteration for geofence zone two, third iteration of the geofence zone three, and the like. At return data send block 2302, return data can be returned from the inferenced model respectively for the multiple iterations of inferencing data. On receipt of the return data sent at block 2302, manager system 110 can proceed to action decision block 1114.

On receipt of the return data sent at block 2302, manager system 110 can proceed to anomaly decision block 1112. At anomaly decision block 1112, manager system 110 can determine whether a risk condition is present. Manager system 110 can ascertain that a risk condition is present, e.g., when a user has raised a condition flagged by implementing remediation action tracked at the most recent iteration of action block 1107. Additionally or alternatively at anomaly decision block 1112, manager system 110 can determine that a risk condition is present by examining of return data returned at block 2302 in reference to current geofence dataset data returned in a most recent iteration of block 1106. As noted with respect to operation of anomaly predictive model 4502, manager system 110 can ascertain that an anomalous person movement pattern is present when predicted missing geofence zone parameter values satisfy a threshold level of difference with respect to an actual current set of geofence zone parameter values. Referring to anomaly decision block 1112, manager system 110 can ascertain that a risk condition is present when system 110 determines that an anomalous person movement pattern is present and that a convergence condition (crowd surge condition) is present using the trained predictive model inferencing methodology described in reference to anomaly predictive model 4502 described in reference to FIG. 4.

On determining at anomaly decision block 1112 that a risk condition is not present, manager system 110 can bypass blocks 1113-1116 and can proceed to return block 1117. On the determination at anomaly decision block 1112 that a risk condition is in fact present, manager system 110 can proceed to send block 1113. At send block 1113, manager system 110 can send inferencing data to impact predictive model 5502 stored in models area 2123 for return of return data sent at send block 2303.

As noted in reference to the description of FIG. 5, return data sent at send block 2303 can include return data that specifies the predicted outcome of several candidate actions associated to several candidate action IDs that are referenced within multiple different iterations of inferencing data that can be presented at send block 1113 to impact predictive model 5502.

On receipt of the return data returned at send block 2303, which can include return data associated to multiple different candidate action IDs, manager system 110 can proceed to action decision block 1114. At action decision block 1114, manager system 110 can perform an action decision to select for implementation one or more remediation action. In one aspect, manager system 110 as set forth in reference to FIG. 5 can select a highest J scoring candidate actions in response to the inferencing of impact predictive model 5502, which can be inferenced using the process described in reference to the inferencing method set forth in reference to FIG. 5, inferencing data send block 1113 and return data send block 2303.

On completion of action decision block 1114, manager system 110 can proceed to send block 1115 and send block 1116. At send block 1115, manager system 110 can, in accordance with the action decision block 1114, send communication data to the UE device associated to the enterprise that is associated to a current geofence array and in response the UE device can perform action at action block 1805. At send block 1116, manager system 110 can send notification and/or command data to the enterprise system of enterprise systems 170A-170Z of the enterprise associated to the current geofence array triggering tracking, and generating at blocks 1105 to 1108, and in response, the enterprise system can perform action as set forth in reference to block 1703. Action at block 1703 can include, e.g., closure and/or locking of gates, doors, corridors, or sensitive areas; adjustments to climate control systems [HVAC]; notification of private security, local authorities; notification or to “call up” reserve employees/labor forces; robotic based responses [i.e., inventory/production responses]; security system initiation, crowd/theft suppression systems, activating a Faraday cage within a venue to disrupt radio communication involving UE devices within the venue, and the like.

On completion of send block 1116 (or alternatively on a no decision being returned at block 1112), manager system 110 can proceed to return block 1117. At return block 1117, manager system 110 can return to stage preceding block 1101 to receive the next iteration of request data sent at block 1801, which can include request data from a current UE device from a last iteration of block 1801 that can include updated request data from the same user that sent request data during the last iteration of block 1801, or, which can include new request data from a new user associated to a new enterprise. It will be understood that manager system 110 can be servicing multiple venues having different respective geofence arrays and different associated enterprise agent users concurrently and simultaneously. Manager system 110 can iteratively perform the loop of blocks 1101 to block 1117 for a deployment period of manager system 110.

On completion of action block 1805, UE devices 180A-180Z can proceed to return block 1806. UE devices 180A-180Z can iteratively perform the loop of blocks 1801 to 1806 during a deployment period of UE devices 180A-180Z.

Enterprise systems 170A-170Z, on completion of action block 1703, can proceed to return block 1704. At return block 1704, enterprise systems 170A-170Z can return to stage preceding install block 1701. And enterprise systems 170A-170Z can iteratively perform the loop at block 1701-1704 during a deployment period of enterprise systems 170A-170Z. It will be understood that in some implementations, install block 1701 can be performed to update and installation and in other use cases and install block 1701 can include performing installation on a computing node of a new enterprise system associated to a newly registered venue and geofence array.

On completion of send block 2303, models area 2123 can proceed to return block 2304. At return block 2304, models area 2123 can return to stage preceding training block 2301. Models area 2123 can iteratively perform the loop blocks 2301-2304 during deployment period of models area 2123.

On completion of send block 1601, sensor system 160 can proceed to return block 1602. At return block 1602, sensor system 160 can return to stage preceding send block 1601. Sensor system 160 can iteratively perform the loop of blocks 1601-1602 during deployment period of sensor system 160. It will be understood that sensor system 160 can be sending sensor data for use in tracking location of persons in and throughout multiple geofence arrays supporting multiple differentiated venues simultaneously and concurrently.

In reference to anomaly predictive model 4502 and impact predictive model 5502, embodiments herein recognize that with use of geofence array 150A-150Z computationally lightweight geofence zone parameter values as set forth in Table A herein can be generated that are lightweight to facilitate computing resource economized training of predictive models.

In one aspect, embodiments herein can remediate flash group venue security breach activity. Embodiments herein recognize that flash group security breach activity is a new phenomenon that poses challenges for venue operators and law enforcement due to its spontaneous and organized nature. Embodiments herein recognize that addressing flash group security breach activity can benefit from a combination of proactive prevention methods, effective security measures, and cooperation between venue operators and law enforcement agencies. Embodiments recognize however that the above combination of approaches can be insufficient to proactively prevent flash group security breach activity as there is currently a lack of effective security measures. Embodiments herein recognize that spontaneous groups have pre-planned their operations and commonly communicate via encrypted social application channels. Embodiments herein recognize that encrypted channel communication can be difficult to detect. In one aspect, embodiments herein can provide meta-detection and inference of risk in reference to flash group venue security breach activity.

Embodiments herein recognize that flash group venue security breach activity can be organized through social media platforms, messaging applications, or other online channels. Embodiments herein recognize that participants are often instructed to gather at a specific time and location, such as a location of a venue. Embodiments herein recognize that once the group assembles, participants quickly enter the venue, some members distract or play other key roles, as the bulk of the organized group commit security breaches in a coordinated manner. Embodiments herein recognize that participants can exit as a group, aiming to overwhelm venue agent users. The goal is to commit a venue security breach within a short period of time. Embodiments herein recognize that the described incidents can be characterized by their speed and chaotic nature. The sudden surge of individuals can make it difficult for venue agent users to react effectively, allowing members of the flash group to make a quick getaway. Embodiments herein can provide an intelligent data inference and response method. Embodiments herein can interpret the convergence of a non-typical, anomalous crowd convergency that may be non-characteristic in a specific environment such as a city.

In one embodiment, data repository 108 of manager system 110 can be populated with real-time anonymous location data identified with a series of layered predefined geofenced virtual boundaries that reside outside of a target location or structure, such as a predefined physical establishment. Manager system 110 can intelligently detect and/or increasingly infer an elevated risk within the predefined custom thresholds (layers) and can permit automated action to be rendered in real time to secure the safety of human life, physical establishments, assets, or other items and commodities of value upon the breach of the system's defined thresholds.

In one embodiment, manager system 110 can be leveraged for auxiliary staff alerting. Some retail establishments have staff working various duties or roles within a business. For example, some enterprise agents defined by employees maybe conducting inventory, or working to stock product in a backroom/warehouse type section of the business, and these employees may be unaware of events transpiring on the sales floor or around their establishment's venue. When an influx of persons cross predefined thresholds and a communications alert, or trigger is tripped manager system 110 can be leveraged to give employees a greater notification period to shift from back stock responsibilities to sales floor-based responsibilities to prevent long lines at registers or negative client satisfaction due to lack of labor/support.

Manager system 110 can be leveraged for crowd control during public events, or events where many individuals will converge, for example, concerts, festivals and presidential inaugurations. Embodiments herein recognize that current methods or crowd control are based primarily on aerial photographs, weather ballon or physically assessing the space occupied by a crowd.

In one embodiment, manager system 110 can be used to alert crowd control staff, public safety enforcement officers and event managers of potential crowd surges that may put at risk the safety of the even participants. Manager system 110 can be employed to provide staff a preemptive alert and an extended notification period when a non-characteristic convergence of people is likely. Crowd control staff and event planners may be alerted and can put in place restrictions such as not allowing access to certain areas, dispersing attendees from areas deemed to be at high risk for crowd surges and activating plans for crowd surge mitigation reducing the risk of potential catastrophic outcomes that may result from crowd surges at large events.

Additional use cases or embodiments may be inclusive of augmented/mixed reality systems and hardware whereas the layers of virtualized boundaries/geofences defined within the system and platform may be visible or detectable in various implementation. Within a game construct the virtualized boundaries/layers/geofenced defined with the game may be inferencing risk of opponent activity and permit the choice of a set of “actions” to be taken within the defined boundaries. Embodiments herein can provide an intelligent data inference and response method. Manager system 110 may interpret the convergence of a non-typical, anomalous crowd convergency.

In one use case, system 100 can be configured to secure health and safety of persons within a geofence array disposed about a venue. Embodiments herein recognize that crowd surges detectable by inferencing of anomaly predictive model 5502 as set forth herein in reference to block 1111 can impose health and safety risks to persons about a venue, e.g., persons can be physically injured by crowd movement and resulting crowd contact. Also, oxygen levels can be reduced via overcrowding. Manager system 110 can be configured to that, on detection of a defined crowd surge at a venue at anomaly decision block 1112, manager system 110 can adjust climate control of the venue (e.g., can activate an HVAC system of an enterprise system associated to the venue to increase oxygen level) and can automatically initiate a loudspeaker notification warning of the surge condition risk.

Embodiments herein can provide a series of layered predefined geofenced virtual boundaries that reside outside of a target location or structure. Embodiments herein can intelligently detect and/or increasingly infer an elevated risk within the predefined custom thresholds (layers). Embodiments herein can permit automated actions to be rendered in real time to secure the safety of human life, physical establishments, assets, or other items and commodities of value upon the breach of the system's defined thresholds. Embodiments herein can provide optional machine learning including reinforcement learning that may be adapted based on particular use cases.

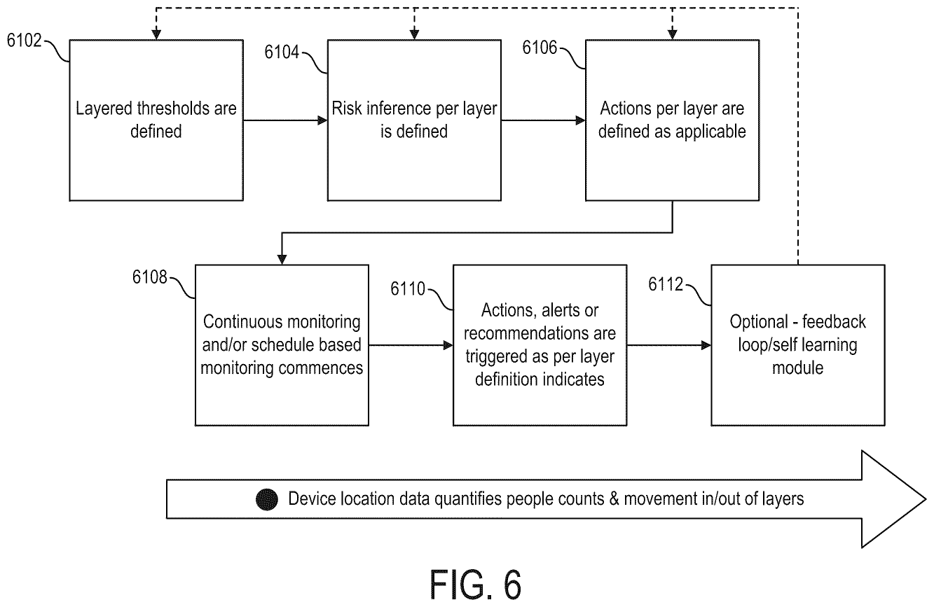

In one embodiment, virtually layered thresholds representing a physical perimeter can be defined and can be adjusted at any point during implementation and/or via additional/optional system features consisting of manual or autonomous feedback loops and/or self-learning mechanisms as set forth in reference to FIG. 6. Layered thresholds can be defined as geofenced virtualized boundaries, as set forth in reference to FIG. 2 typically consisting of one or more geofence representations around a particular address, asset, or target location. Layers equal to or greater than one outside a primary virtualized boundary can be represented in any configuration or shape suitable to the application or use case, i.e., square, circle, non-defined, etc. The primary virtualized boundary, e.g., geofence 1 in FIG. 2 can take on the boundary shape of the area protected, or can be of another shape. In reference to FIG. 6, manager system 110 at block 6102 can receive input data, e.g., responsively to configuration data send block 1803 (FIG. 3A-3B) defining layered thresholds. At block 6104, manager system 110 can receive input data, e.g., responsively to configuration data send block 1803 defining a risk inference per layer. At block 6106, manager system 110 can receive input data, e.g., responsively to configuration data send block 1803 defining actions per layer. At block 6108, manager system 110 can perform continuous monitoring and/or scheduling. At block 6110, manager system 110 can trigger actions, alerts, etc. At block 6112, manager system 110 can perform self-learning via machine learning.

An administrator developer user can choose from a variety of methods for configuring a geofence. For configuration of a queryable geofence, various technologies can be employed. The Web Geolocation API (W3C standard) allows web applications to access a user's location, but it requires user consent and has limited background tracking capabilities. For mobile applications, Apple's Core Location framework (part of iOS®) provides geofencing functionality, allowing apps to trigger events when a user enters or exits a predefined region. On Android™, Google Play services' Location API supports geofencing with efficient battery management. Google Maps Platform™ offers geospatial data, including the Google Maps JavaScript API for web-based geofencing visualization and the Geocoding API for converting addresses into geographic coordinates. GeoJSON, an open format, can also define geofence boundaries for interoperability with mapping tools. Additionally, third-party geofencing SDKs like Radar®, GeoSpark®, and Mapbox® provide enhanced geofencing features with real-time analytics. For IoT applications, AWS IoT Core for LoRaWAN® and Azure Maps Geofencing API enable location-based event triggering. These technologies collectively help developers configure and query geofences efficiently across web, mobile, and IoT platforms. A geofence can be implemented as a microservice, exposing a RESTful or GraphQL API for querying and managing geofences. Clients define geofences via a POST/geofences request with coordinates, while location updates are sent to POST/location-updates. To check geofence status, applications query GET/geofences/{id} or send a POST/geofence-check request with current coordinates. The microservice processes location data and triggers events—via webhooks, push notifications, or MQTT—when users enter or exit geofenced areas. This architecture ensures scalability, modularity, and cross-platform integration, making it ideal for real-time tracking and location-based automation. It can integrate with mapping services like Google Maps Platform™, Mapbox®, and mobile location APIs such as Core Location (iOS®) and Google Play Services Location API (Android™). By leveraging microservices, geofencing systems become more flexible, efficient, and easier to manage across various applications and IoT ecosystems.

In one embodiment, an administrator developer user can configure manager system 110 to access historical location-based data to better develop the system on historical records whereas the system establishes typical people movement in/out of a defined threshold. This establishes a normalcy or known baseline that is indicative or minimized/low risk.

An administrator developer user may explore/leverage data providers and services that offer historical mobility/location based/tracking data as a service. These platforms/data sources may include location data aggregators, geospatial analytics platforms, location-based services, or may be government agencies that provide historical transportation or demographic data. This data can be aggregated across a multitude of vendors or providers and may have sources derived from various sensors or combination of sensors such as GPS inference, Bluetooth, Wi-Fi, cellular signals, or other methods to anonymously infer location of an individual(s). In various other embodiments, applications or use cases these same location tracking/inference methods may additionally represent vehicles, robots, animals, or other non-human objects/assets of concern/measure rather than an individual(s). Once data is acquired, an historical baseline should be established for the layers. An administrator developer user can follow approaches from the below to establish such histories.

In one aspect, manager system 110 can employ clustering algorithms for tracking individual trajectories. Clustering algorithms for tracking individual trajectories in location-based analytics operate by grouping similar movement patterns based on spatial and temporal proximity. These algorithms analyze raw trajectory data, often represented as sequences of location points over time, to detect common routes, anomalies, or patterns in movement. Some methods segment trajectories into smaller parts before clustering, while others directly cluster entire paths based on distance, direction, or density.

Density-based algorithms (e.g., DBSCAN) identify clusters of frequently traveled paths while filtering out noise. Partition-based methods (e.g., k-means) assign trajectory points to predefined clusters, helping detect mobility trends. Subspace clustering (e.g., CLIQUE®) identifies movement trends across multiple dimensions, such as time and speed. Trajectory clustering (e.g., TRACLUS) segments and groups trajectory segments based on similarity.

Manager system 110 can employ spatial analysis for performance of spatial joins, buffer analysis and route analysis. Spatial analysis involves processing geographic data to extract meaningful insights, often using techniques such as spatial join, buffer analysis, route analysis, and spatial clustering. Spatial join combines attribute data from two spatial datasets based on their geographic relationship, enabling applications like mapping customer locations to service areas or linking crime incidents to neighborhoods. Buffer analysis creates zones around a point, line, or polygon at a specified distance to assess proximity, commonly used in retail site selection, environmental impact studies, and emergency response planning. Route analysis calculates the most efficient paths between locations, optimizing navigation for fleet management, ride-sharing, and logistics routing. Spatial clustering identifies patterns in location data by grouping nearby points, using methods like DBSCAN for density-based clustering or k-means for partitioned clustering, useful for hotspot detection.

Manager system 110 can perform temporal analysis. Manager system 110 can perform temporal analysis using ARIMA (AutoRegressive Integrated Moving Average) by modeling time-series data to capture trends, seasonality, and patterns for forecasting. The process begins with data preprocessing, where missing values are handled, and the time series is checked for stationarity—ensuring its statistical properties remain consistent over time. If the data is non-stationary, differencing is applied to stabilize variance. Next, the ARIMA model can be parameterized using three components: AR (AutoRegressive) order (p), which considers past values; I (Integration) order (d), which accounts for differencing; and MA (Moving Average) order (q), which smooths noise using past error terms. The best parameters are typically identified using techniques like ACF (Autocorrelation Function) and PACF (Partial Autocorrelation Function) plots. The model can be trained on historical data and validated using techniques like cross-validation or out-of-sample testing. Finally, forecasts can be generated and evaluated for accuracy using metrics like Mean Absolute Error (MAE) or Root Mean Squared Error (RMSE).

Once these methods have been leveraged across available data, manager system 110 can provide a baseline of person movement/trajectories. From the baseline, the data can be better represented and understood helping form a hypothesis or forecast of future person movement trends. Data can be refreshed and refined in a continuous manner to ensure accuracy of data and platform calculations.

An administrator developer user, e.g., with input data sent at block 1803 can define thresholds and risk inferences for the layered/virtualized boundaries/geofenced perimeters identified for and within system 100.

In one example, local or municipal event authorities/services, vehicle traffic management, governments, and potentially an/all in coordination with event management software platforms may identify and/or offer event calendars, construction/road closure schedules, “permit” (for large crowds/other) application notifications as additional contextual inputs that may influence the trajectories of individuals within defined virtual boundaries. In one embodiment, enterprise systems of enterprise systems 170A-170Z can include, e.g., weather service systems, and news aggregator systems.

In one embodiment, risk levels can be represented as concentric geofences as set forth in reference to FIG. 2, with each layer moving inward increasing the risk factor or inferred risk. As manager system 110 portrays a detectable, anomalous influx of location-based-correlated-human activity that begins to decrease a distance from the epicenter/fixed location within the layered position, risk may be measured as a distance value according to rules based criteria as set forth in Table D.

TABLE D
Distance = 0: Outside of Layer 1 (no risk)
Distance > 0 and <= R1: Inside Layer 1 (low risk)
Distance > R1 and <= R2: Inside Layer 2 (moderate risk)
Distance > R2 and <= R3: Inside Layer 3 (high risk)
Here, R1, R2, and R3 are the radii of the three concentric defense layers.

Pseudocode for correlation of risk inferences and actions with mitigations triggers are set forth in reference to Table E.

```
TABLE E
Spike in Real Time Location Data/Indicators
Represented in code using conditional statements (if-else) to determine
level of risk.
# Define the radii of the defense layers
R1 = 10 # Radius of Layer 1
R2 = 20 # Radius of Layer 2
R3 = 30 # Radius of Layer 3
# Access risk and take action
def assess_risk_and_take_action(distance_from_center):
  if distance_from_center <= 0:
    print(“Outside of Layer 1: No risk.”)
  elif 0 < distance_from center <= R1:
    print (“Inside Layer 1: Low risk. Prepare for potential threat.”)
    # You might want to prepare and be attentive, but no
    immediate action.
  elif R1 < distance_from_center <= R2:
    print(“Inside Layer 2: Moderate risk. Ready your defense.”)
    # Mob Approaching! Shut the Gates!
  elif R2 < distance_from_center <= R3:
    print(“Inside Layer 3: High risk. Alert Private Security.”)
    # Lock High End Valuables, Alert Private Security, Initiate
    Safety Protocols.
# Your current distance from the center
Current_distance = 15 # Change this value as the situation evolves
# Call the function to assess the risk and take action based on your
current distance
assess_risk_and_take_action(current_distance)
High Risk Permitter Breach
```

Examples of remediation actions can include, e.g., closure and/or locking of gates, doors, corridors, or sensitive areas; adjustments to climate control systems [HVAC]; notification of private security, local authorities; notification or to “call up” reserve employees/labor forces; robotic based responses [i.e., inventory/production responses]; security system initiation, crowd/theft suppression systems, activating a Faraday cage.

System 100 can be configured by an administrator developer user to learn and adapt to evolving threats in a geofenced (layered) environment, and improve upon such over time. In one embodiment, manager system 110 can identify states, like which geofence layer an individual or group is in (geofence zone 3, geofence zone 2, geofence zone 1) their movement speed, how long they've remained within a particular geofence layer, and the density of devices in the area. Based on this, manager system 110 can evaluate possible actions like notifying staff, triggering a red warning light, or doing nothing and chooses the one that's most likely to yield the best outcome.

Training of impact predictive model 5502 can be differentiated from the training described in reference to FIG. 5 and impact predictive model 5502 can feature a variety of different architectures. In one embodiment, impact predictive model 5502 can be defined by a Q-table, and in one embodiment impact predictive model 5502 can be trained with use of deep Q-learning. Manager system 110 can learn what works by assigning rewards to different actions. For example, preventing a theft earns a reward (+23), while triggering a false alarm earns a penalty (−23). Historical data serves as the foundation for this learning. Manager system 110 can perform training episodes that capture the story of each scenario: the state, the action taken, the reward received, and the resulting state transition. Using Bellman's Equation, manager system 110 can update a Q-table or similar data categorization, iteratively, improving its understanding of which actions are best for any given situation.

In real time, manager system 110 can monitor live data from geofences surrounding a target area which may be defined in layers or thresholds that may represent risk, in which it is tracking movement, velocity, dwell times, and other contextual factors that may help to enhance the system's overall accuracy based on the use case or environmental attributes or conditions. Manager system 110 can employ a trained Q-table to identify the best action for the current state. For instance, if a group remains in zone 2 with a high device density and an unusual dwell time, manager system 110 might decide to trigger an action such as a ‘red warning light’ for the staff to be alerted because the system has learned this is the most effective action based on what was used in various other similar situations.

The described operation can be continuous. Manager system 110 can log real-world outcomes specifying whether the action succeeded or failed and can use this feedback to refine its decisions over time. If the environment becomes more complex let us say, with factors like time of day, weather, or crowd dynamics then manager system 110 can be scaled to an enhanced Q-table for Deep Q-learning (DQN). Deep Q-learning can replace the Q-table with a neural network that can handle more nuanced inputs and deliver more sophisticated predictions. However, the concepts of using historical and peripheral data obtained by user/device/node/people data remains the same.

Embodiments herein can provide a smart, adaptive system that learns from the past, reacts to the present, and continuously improves to protect defined assets and reduce risks. Whether remediation involves triggering the warning light or escalating to emergency response systems, engaging crowd/theft suppression systems, manager system 110 ensures decisions are timely, effective, iterative in training, and resulting output and/or actions grounded in best known data.

Manager system 110 can perform gathering historical data that shows what happened in similar situations in which you wish to identify. For example, manager system 110 can collect details as are set forth in Table F.

TABLE F
Which geofence layer the person or group was in (green-outer, yellow-middle, red-inner).
How fast they were moving (velocity)
How long they stayed in one place (dwell time).
How crowded the area was (device density).
What action was taken or what action you took (triggered a warning light, notified staff, called 911, or
did nothing)
What happened next (did the system or 'you' prevent theft, was it a good thing or was it a false alarm
and a not so good thing?)
Next, assign rewards to these outcomes. Positive rewards (like +23) go to actions that worked, such as
stopping theft. Negative rewards (like −23) are for false alarms or actions that missed a problem.
From there the data needs structure, organized into data episodes or mini-episodes, which are
essentially “mini-stories” formatted as (current situation, action, result, next situation) that complete
the interactions throughout the ‘data cycle’ being examined.

Next, manager system 110 can commence training. In one embodiment, manager system 110 can perform training with Q-Learning. In one embodiment, impact predictive model 5502 can be defined by a Q-table. The use of geofence zone parameter values can reduce training resource consumption irrespective of the architecture of the machine learning model defining impact predictive model 5502. While geofence zone parameter values can reduce training resources irrespective of architecture, computing resource consumption can particularly economized with use of Q-table based Q-learning. Training a Q-table can consume significantly reduced computing resources relative to training a neural network due to differences in memory usage, computational complexity, and algorithmic structure. A Q-table explicitly stores values for each state-action pair, making it a fixed-size, tabular representation. This approach is highly efficient when dealing with small, discrete environments, as updates to the Q-values involve simple arithmetic operations rather than complex matrix calculations. In contrast, neural networks require multiple layers of neurons, each with numerous trainable weights, leading to increased memory consumption and processing demands. The computational complexity of updating a Q-table follows the Bellman equation, which involves only basic arithmetic operations such as addition, subtraction, and scalar multiplication. On the other hand, training a neural network involves forward propagation, backpropagation, and weight updates using optimization techniques like stochastic gradient descent, requiring expensive matrix multiplications and gradient computations. Furthermore, Q-learning updates are localized to a single state-action pair, whereas neural networks adjust many weights across multiple layers, making training significantly more resource-intensive. Another key factor is that Q-tables do not require backpropagation, whereas deep reinforcement learning models like deep Q-networks (DQN) rely on it, further increasing computational overhead.

Manager system 110 can teach the system how to make decisions by setting up a Q-table. Each row represents a specific profile, like zone 2, fast-moving group (e.g., which can be specified with growth rate of zone 2 satisfying a threshold), and each column represents an action, like “notify staff” or “trigger the red light.” Manager system 110 can perform initializing the table with zeros indicating that no decisions are better than others yet.

To fill in the Q-table, manager system 110 can employ Bellman's equation, which updates the value of a decision based on how positive the decision turned out to be. Bellman's equation is used to iteratively update the Q-table by refining action-value estimates based on observed rewards and future expectations. The equation, Q(s,a)=Q(s,a)+α[R+γmaxQ(s′,a′)−Q(s,a)]Q(s, a)=Q(s, a)+\alpha[R+\gamma\max Q(s′, a′)−Q(s, a)]Q(s,a)=Q(s,a)+α[R+γmaxQ(s′,a′)−Q(s,a)], ensures that each state-action pair is adjusted dynamically as the system learns from new experiences. Initially, the Q-table contains random values, and with each iteration, a random profile (state) and action are selected, followed by receiving a reward (success=+23, failure =−23). The update process incorporates both the immediate reward and the best estimated future value, allowing actions that consistently yield high rewards to gain higher Q-values while poor actions are penalized. By iteration 5, early trends emerge where successful actions are reinforced, while by iteration 525, the Q-table has refined its values to reflect optimal decision-making patterns. The learning rate (a\alphaa) ensures that early updates have more impact, while the discount factor (y\gammay) balances immediate and future rewards. Over time, the Q-values stabilize, converging towards an optimal policy where the highest values represent the best actions for each profile. This method allows reinforcement learning systems to adapt dynamically, progressively favoring high-reward choices. By continuously updating based on Bellman's principle, the model effectively learns from trial and error, improving its decision-making strategy. At iteration 525, the Q-table exhibits well-trained values, guiding future actions with data-driven insights. This iterative learning process is foundational in AI applications like robotics, game playing, and recommendation systems, ensuring adaptive and optimized performance. Through Bellman's equation, the system learns the most effective actions for different situations, reinforcing a structured and scalable approach to machine learning-based decision-making.

Manager system 110 can iterate training using historical data. For each training iteration, manager system 110 can adjust the Q-values in the table based on the reward the action received and what's likely to happen next. The more times manager system 110 updates the Q-table via iterations of training data, the smarter the Q-table becomes in respect to what actions are worth taking.

A Q-table at iteration 0 can be provided as set forth in Table G.

TABLE G

| Row | Profile | Action 1 | Action 2 | Action 2 |
|---|---|---|---|---|
| 1 | Profile 1 | 0.0 | 0.0 | 0.0 |
| 2 | Profile 2 | 0.0 | 0.0 | 0.0 |
| 3 | Profile 3 | 0.0 | 0.0 | 0.0 |
| 4 | Profile 4 | 0.0 | 0.0 | 0.0 |
| 5 | Profile 5 | 0.0 | 0.0 | 0.0 |

After 5 iterations, the Q-table can be provided as set forth in Table H. Profiles can be defined based on datasets comprising one or more geofence zone parameter value as set forth in Table A. When an anomalous person movement condition defining a risk condition is detected at anomaly decision block 1112, manager system 110 can generate a profile for population of a Q-table based on one or more geofence zone parameter value prevailing at the time of the detecting, e.g., one profile can be that a growth geofence zone parameter value satisfies a threshold. In another use case, the profiles can be established by an administrator developer user with use of the user interface installed at install block 1802.

TABLE H

| Row | Profile | Action 1 | Action 2 | Action 2 |
|---|---|---|---|---|
| 1 | Profile 1 | 8.08 | −17.56 | 32.66 |
| 2 | Profile 2 | 23.04 | 27.12 | 24.66 |
| 3 | Profile 3 | 4.07 | 20.16 | 11.02 |
| 4 | Profile 4 | 29.32 | 5.81 | 42.02 |
| 5 | Profile 5 | 8.71 | 48.04 | 20.79 |

After 525 iteration, the Q-table can be provided as set forth in Table I.

TABLE I

| Row | Profile | Action 1 | Action 2 | Action 2 |
|---|---|---|---|---|
| 1 | Profile 1 | −56.08 | −28.65 | −99.02 |
| 2 | Profile 2 | 23.15 | −4.27 | 58.54 |
| 3 | Profile 3 | −10.85 | −12.74 | −7.61 |
| 4 | Profile 4 | −16.12 | 20.72 | 29.52 |
| 5 | Profile 5 | 14.14 | 3.93 | 2.11 |

Once the Q-table is trained, manager system 110 can employ the trained Q-table to start making decisions on its own. Manager system 110 can monitor live geofence data, like which geofence zone (layer) someone is in, how fast they are moving, and their dwell time. Based on this live input, manager system 110 can reference the Q-table and select the action with the highest score for the current situation (note the table can always be adjusted, weights adjusted and retrained if necessary). For returning an action decision at block 1114, manager system 110 in one embodiment can inference the Q-table as shown in Table I using one or more current geofence zone parameter value as generated at block 1106 to identify any currently active row from the Q-table (manager system 110 can determine that a certain row associated to a certain candidate profile of is active based on the current geofence zone parameter value data matching the condition expressed by the certain candidate profile). Then, from the identified active row(s), manager system 110 can select for implementation the action associated to the highest scoring column from the identified active row(s). In one embodiment, manager system 110 can qualify the selected action by requiring that any selected action have a positive score.

Manager system 110 can implement the action indicated and previously learned, whether it's notifying staff, turning on the red warning light, calling 911, or doing nothing at all based on the input being examined. Manager system 110 can system log what happened after the action so it can use this feedback to improve in the future and either reinforces what it thought was accurate or deviates from that and applies self-correction based on the weights.

Manager system 110 can be configured for continual improving. Manager system 110 can feed new results from real-world actions back into the Q-table. Manager system 110 can retrain the system periodically so it stays sharp. If there are multiple disconnected systems that have learned independently, then those systems that have learned independently may be combined into a larger corpus of unified systems, whereas by combing or sharing their data and models such as the ‘replay buffers’, integrating neural networks through weight sharing or leveraging methods to reinforce shared patterns from diverse historical data, diverse training data, and diverse outcomes from real world environments whereas the system has self-learned and yields its teachings to joined systems.

In use cases where system 100 grows or starts facing increasingly multidimensional scenarios such as temporal patterns, like factoring in time of day, dynamic conditions weather, crowd size influences, or bus schedules, new data sources or intelligence, manager system 110 can be configured to implement deep Q-learning (DQL). In some embodiments, DQL can replace the Q-table for Q-learning altogether. In some embodiments, the Q-table can be swapped out for a neural network that can handle these additional layers of complexity. In such embodiments, the Q function essentially become scalable via this higher dimensional data.

For DQL the implementation slightly differs as the administrator developer can combine geofence layer, velocity, dwell time, device density, and other contextual/dimensional data into a feature vector, as the ‘input features’. Manager system 110 can apply the Bellman equation for a DQL implementation to obtain desired actions/states, and the target can be the updated Q-value for a or all state-action pair or ‘target output’. Training of impact predictive model 5502 where predictive model 5502 incorporates deep Q-learning can include application of training rules as set forth in Table J.

```
TABLE J
Q(s,a) ← r+γa′maxQ(s′,a′)
target_q = reward
if not done:
    target_q += gamma * np.max(model.predict(next_state))
Q(s,a) = current state's Q-value for the action a
r = immediate reward after taking action a
γ = discount factor, determining the importance of future rewards.
Immediate Reward -
  target_q = reward ensures the immediate reward r is always considered.
Future Reward -
If the next state is not terminal (if not done), add the discounted maximum
Q-value for the next state.
```

Manager system 110 in a forward pass can feed the current state and action into the neural network to predict Q-values, such as predicting the q value for the next state, or current state or selecting the action during training.

Manager system 110 in a backward pass, can adjust the neural network weights using the difference between the predicted Q-value and the target Q-value as the error. This is happening during our training states whereas the system updates those weights through an optimization algorithm such as stochastic gradient descent (SGD-momentum, SGD-adam). where the probability of random actions decreases over time, enabling the system to focus on reliable decisions.

Manager system 110 can store a memory buffer of recent experiences in the format (state, action, reward, next state, done) Here the done flag shows if the episode has ended. Sample batches of experiences by randomly picking (exploration of) experiences from the buffer. This randomness prevents the system from overfitting to specific patterns in the data which should be avoided and managed via an epsilon greedy strategy or similar randomness reduction methodology. Use the DQNN best predictions (exploitation of) as they become available to the system overall learned actions grounded in reliability. Once deployed, manager system 110 continues to refine itself. Actions and results in the live environment are logged, and the neural network is periodically retrained with this new data. This ensures the model adapts to evolving conditions, such as changes in user behavior or external factors like seasonal patterns that change people patterns influenced by weather.

Various available tools, libraries, and/or services can be utilized for implementation of trained predictive models herein trained by machine learning, such as predictive model 4502, and/or predictive model 5502. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

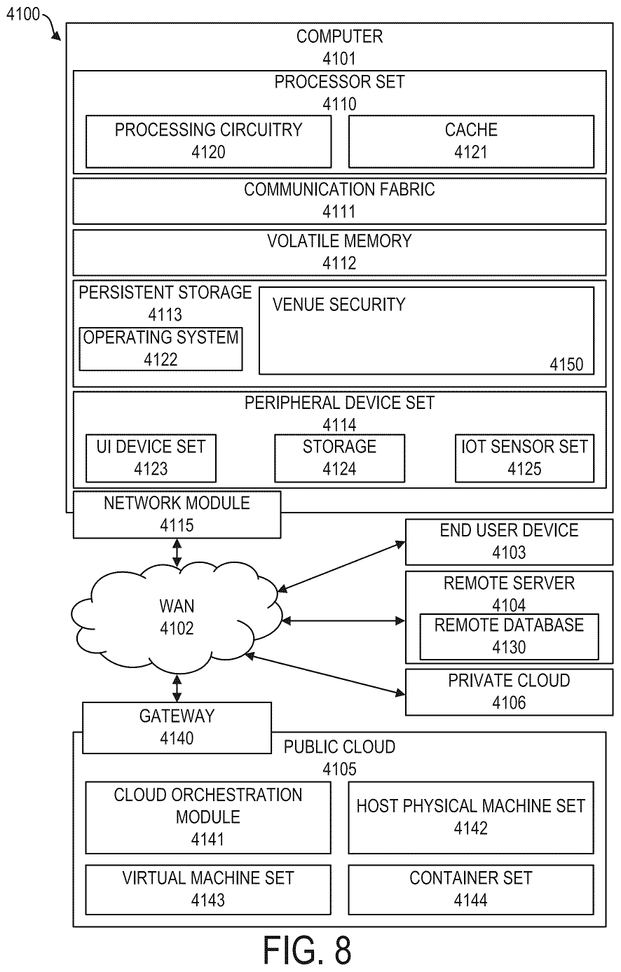

FIG. 8 is an illustration of an example ANN architecture for trained predictive models herein trained by machine learning, such as predictive model 4502, and/or predictive model 5502.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as the applications discussed in connection with 4502, and/or predictive model 5502.

Referring now to FIG. 8, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referring to as outcome training data as referenced in connection with predictive models 4502, 5502 herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer system. Embodiments herein recognize that tracking granular trajectories of multiple persons can consume extensive computing resources. The providing of a geofence array having one or more geofence and providing of classifications for geofence zone parameter values based on geofence zone can facilitate resource economized training of machine learning predictive models. Particular geofence zone parameter value herein reduce dimensionality and economize computing resources. Embodiments herein can feature a geofence array that provides security to venue such as a brick-and-mortar or outdoor venue. Machine learning predictive models herein can be trained and inferenced for use, e.g., in detecting of anomalous person movement patterns about a venue, as well as for predicting impact of a candidate remediation action for remediating a risk condition associated to a venue. Unlike a conventional user interface which may merely present static information to a user, embodiments herein define an enhanced user interface which passively obtains user input data, e.g., in the form of location data of groups of users of a venue (e.g., authentic venue users) and adaptively responds to detected risk conditions for enhanced venue security. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources such as data sources that process radio signals for location determination of users. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

In reference to FIG. 8 there is set forth a description of a computing environment 4100 that can include one or more computer 4101. In one example, computing node 10 as set forth herein can be provided in accordance with computer 4101 as set forth in FIG. 8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

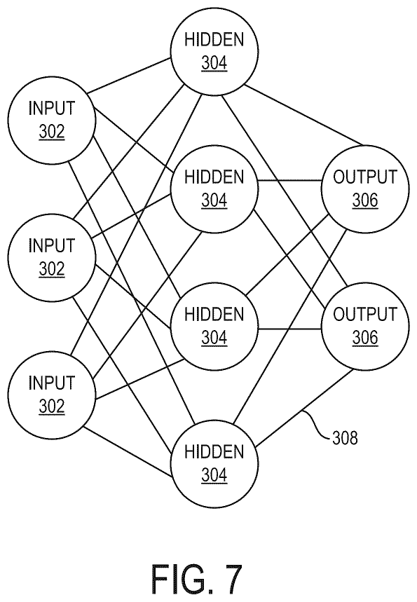

One example of a computing environment to perform, incorporate and/or use one or more aspects of the present invention is described with reference to FIG. 8. In one aspect, a computing environment 4100 contains an example of an environment for the execution of at least some of the computer code involved in performing the inventive methods, such as code 4150 for performing venue security described with reference to FIGS. 1-8. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IOT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
obtaining location data of a plurality of persons in a geospatial region coinciding with a geofence array, wherein the geofence array includes a geofence disposed about a venue, the geofence array defining a plurality of geofence zones;
classifying persons of the plurality of persons in dependence on the location data as belonging to a certain zone of the plurality of geofence zones;
generating geofence parameter values for the certain zone of the plurality of geofence zones, wherein the generating is performed in dependence on the classifying;
inferencing one or more predictive model in dependence on a parameter value of the geofence parameter values; and
initiating action for remediation of a security risk condition associated to the venue in dependence on result data resulting from the inferencing.

2. The computer implemented method of claim 1, wherein the method includes detecting an anomalous person movement pattern in dependence on the result data resulting from the inferencing, and performing the initiating action for remediation of the risk condition associated to the venue in response to the detecting.

3. The computer implemented method of claim 1, wherein the geofence array includes the geofence and a second geofence, the geofence nested within the geofence.

4. The computer implemented method of claim 1, wherein the geofence array includes the geofence and a second geofence, the geofence nested within the geofence, wherein a first geofence zone is defined as an area internal to the geofence, wherein a second geofence zone is defined as an area between the geofence and the second geofence.

5. The computer implemented method of claim 1, wherein the classifying includes classifying persons of the plurality of persons in dependence on the location data as belonging to a particular zone of the plurality of geofence zones, and wherein the generating includes generating geofence parameter values for the particular zone of the plurality of geofence zones.

6. The computer implemented method of claim 1, wherein the classifying includes classifying persons of the plurality of persons in dependence on the location data as belonging to a particular zone of the plurality of geofence zones, and wherein the generating includes generating geofence parameter values for the particular zone of the plurality of geofence zones, wherein the predictive model is a machine learning neural network predictive model training by self-supervised learning, wherein training iterations for training the machine learning neural network predictive model training by self-supervised learning, include alternately applying historical instances of the generated geofence parameter values for the certain zone and the particular zone as input training data and outcome training data.

7. The computer implemented method of claim 1, wherein the geofence array includes the geofence, a second geofence and a third geofence, the geofence nested within the second geofence, the second geofence nested within the third geofence, wherein a first geofence zone is defined as an area internal to the geofence, wherein a second geofence zone is defined as an area between the geofence and the second geofence, and wherein a third geofence zone is defined as an area between the second geofence and the third geofence.

8. The computer implemented method of claim 1, wherein the predictive model is a trained machine learning model trained by machine learning, wherein the predictive model has been trained with use of historical instances of geofence parameter values generated with use of historical instances of performing the generating, the classifying and the obtaining.

9. The computer implemented method of claim 1, wherein the predictive model is a trained machine learning model trained by machine learning, wherein the predictive model has been trained with use of historical instances of geofence parameter values generated with use of historical instances of performing the generating, the classifying and the obtaining, wherein the predictive model has been trained with use of self-supervised learning, wherein for training the predictive model by self-supervised learning, historical instances of the geofence zone parameter values for the geofence zone are alternatively applied as input training data and outcome training data to the predictive model.

10. The computer implemented method of claim 1, wherein the one or more predictive model includes an impact predictive model that predicts an impact of performing an action with respect to the venue, wherein the impact predictive model has been trained with training data referencing historical actions in respect to the venue, and historical outcomes associated the historical actions.

11. The computer implemented method of claim 1, wherein the one or more predictive model includes an impact predictive model that predicts an impact of performing an action with respect to the venue, wherein the impact predictive model has been trained with training data referencing historical actions in respect to the venue, and historical outcomes associated the historical actions, wherein the inferencing includes inferencing the impact predictive model with inferencing data referencing multiple candidate actions with respect to the venue, and wherein the initiating action include selecting from the multiple candidate actions in dependence on result data resulting from the inferencing the impact predictive model with inferencing data referencing multiple candidate actions with respect to the venue.

12. The computer implemented method of claim 1, wherein the inferencing includes inferencing one or more predictive model trained by Q-learning.

13. The computer implemented method of claim 1, wherein the inferencing includes inferencing a Q-table trained by Q-learning.

14. The computer implemented method of claim 1, wherein the inferencing includes inferencing a neural network trained by deep Q-learning.

15. The computer implemented method of claim 1, wherein the initiating action for remediation of a security risk condition includes initiating closing a gate to the venue.

16. The computer implemented method of claim 1, wherein the initiating action for remediation of a security risk condition includes adjusting climate control of the venue.

17. The computer implemented method of claim 1, wherein the method includes discovering a risk condition of the venue responsively to the inferencing.

18. The computer implemented method of claim 1, wherein the method includes discovering a crowd surge risk condition of the venue responsively to the inferencing, and wherein the initiating action for remediation of a security risk condition includes adjusting climate control of the venue responsively to the discovering the crowd surge risk condition.

19. A system comprising:
a memory;
at least one processor in communication with the memory; and
program instructions executable by one or more processor via the memory to perform operations comprising:
obtaining location data of a plurality of persons in a geospatial region coinciding with a geofence array, wherein the geofence array includes a geofence disposed about a venue, the geofence array defining a plurality of geofence zones;
classifying persons of the plurality of persons in dependence on the location data as belonging to a certain zone of the plurality of geofence zones;
generating geofence parameter values for the certain zone of the plurality of geofence zones, wherein the generating is performed in dependence on the classifying;
inferencing one or more predictive model in dependence on a parameter value of the geofence parameter values; and
initiating action for remediation of a security risk condition associated to the venue in dependence on result data resulting from the inferencing.

20. A computer program product comprising:
a computer readable storage medium readable by one or more processing circuit and storing instructions for execution by one or more processor for performing operations comprising:
obtaining location data of a plurality of persons in a geospatial region coinciding with a geofence array, wherein the geofence array includes a geofence disposed about a venue, the geofence array defining a plurality of geofence zones;
classifying persons of the plurality of persons in dependence on the location data as belonging to a certain zone of the plurality of geofence zones;
generating geofence parameter values for the certain zone of the plurality of geofence zones, wherein the generating is performed in dependence on the classifying;
inferencing one or more predictive model in dependence on a parameter value of the geofence parameter values; and
initiating action for remediation of a security risk condition associated to the venue in dependence on result data resulting from the inferencing.
